(19) United States
(12) Patent Application Publication
(10) Pub. No.: US 2008/0177747 A1
(43) Pub. Date: Jul. 24, 2008

(54) SYSTEM AND METHOD FOR COMPOSITION OF DOCUMENTS FROM MULTIPLE FORMATS

(76) Inventor: Michael YEUNG, Mission Viejo, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/626,828

(22) Filed: Jan. 24, 2007

(51) Int. Cl. G06F 17/30

(52) U.S. Cl. 707/10; 707/E17.032

(57) ABSTRACT

The subject application is directed to a system and method for composition of documents from multiple formats. Document selection data representing a selected set of a plurality of electronic documents encoded in mutually distinct formats is first received. Document data, including link data associated with a link to each selected electronic document and metadata associated with the format of each selected electronic document are stored. Finishing data is then received, which represents at least one output form associated with an output document. An output is then commenced to an associated document processing device corresponding to each of the selected set of electronic documents and corresponding document data. Thereafter, an associated document processing device commences an output of an output document including each selected electronic document according to the received finishing data.

### BACKGROUND OF THE INVENTION

The subject application is directed to a system and method for composition of documents from multiple formats. In particular, the subject application is directed to a system and method for composing or assembling a document from multiple files or software applications.

Electronic documents exist in multiple different formats. By way of example only, such formats include .doc, .xls, and .ppt formats used by various MICROSOFT OFFICE products, Portable Document Format (“PDF”) documents from Adobe Systems, image files, such as .gif, .jpg, .pcx, .tiff, .raw, .png, and .dwg, and vector format documents, such as .dxf files. In addition, files exist that are already in one or more formats associated with an output device, such as a printer.

Many reports currently require users to assemble documents including portions from multiple sources. For example, there may be a written portion, with appendices or attachments inclusive of spread sheets, scanned documents, facsimiles received and graphs, such as pie charts. Currently, a user must launch individual applications associated with each document type, and then generate an output, such as printout of each. In many instances, multiple copies must be made. So there is a time consuming, manually intensive procedure by which each document component is selected, printed out, collated, and assembled, multiple times.

A user of a document processing device, such as a multifunctional peripheral device, may desire to generate a document or report, wherein such document is comprised of electronic documents or other data from different files or applications. For example, a user may desire to generate a marketing report showing sales reports, marketing analyses, sales goals, and other marketing information. It is likely that each component of the report would be in a different file, format, or application. The user would have to open each file separately, and then print each file. Once all of the files are printed, the user would have to assemble the documents and perform any finishing options required for the report, such as stapling or binding.

### SUMMARY OF THE INVENTION

In accordance with one embodiment of the subject application, there is provided a system and method for composition of documents from multiple formats.

Further, in accordance with one embodiment of the subject application, there is provided a system and method for generating an electronic document from multiple sources.

Further, in accordance with one embodiment of the subject application, there is provided a system and method that allows a user to compose or assemble a document from multiple files or software applications.

Still further, in accordance with one embodiment of the subject application, there is provided a system for composition of documents from multiple formats. The system includes means adapted for receiving document selection data representative of a selected set of a plurality of electronic documents encoded in mutually distinct formats and data storage adapted for storing document data. The document data includes link data associated with a link to each selected electronic document and metadata associated with a format of each selected electronic document. The system further comprises means adapted for receiving document finishing data representative of at least one output form associated with an output document and means adapted for commencing an output corresponding to each of the selected set of electronic documents and corresponding document data to an associated document processing device. The system also includes output means adapted for commencing an output, via the associated document processing device, of an output document inclusive of each selected electronic document in accordance with received finishing data.

In one embodiment of the subject application, the finishing data includes data representative of at least one output form chosen from the set comprising stapling, number of copies, collation and cover page generation.

In another embodiment of the subject application, the system further comprises a printer driver resident on a workstation. The printer driver includes means adapted for generating a user interface inclusive of image data representative of the at least one output form and means adapted for retrieving each selected electronic document in accordance with document selection data. In this embodiment, the means adapted for receiving the document finishing data is disposed within the printer driver.

In yet another embodiment of the subject application, the user interface includes an icon corresponding to each output form. In this embodiment, the system further comprises means adapted for receiving the document finishing data in accordance with a user selection of an icon on the user interface.

In a further embodiment of the subject application, the system further comprises means adapted for generating image data representative of the selected set of electronic documents and means adapted for receiving ordering data representative of a selected ordering of each of the selected set of electronic documents. In this embodiment, the output means includes means adapted for commencing an output of the output document in accordance with received ordering data.

Still further, in accordance with one embodiment of the subject application, there is provided a method for composition of documents from multiple formats in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system for composition of documents from multiple formats according to one embodiment of the subject application;

FIG. 2 is a block diagram illustrating controller hardware for use in the system for composition of documents from multiple formats according to one embodiment of the subject application;

FIG. 3 is a functional diagram illustrating the controller for use in the system for composition of documents from multiple formats according to one embodiment of the subject application;

FIG. 4 is a block diagram illustrating a workstation for use in the system for composition of documents from multiple formats according to one embodiment of the subject application;

FIG. 5 is a template of a workflow toolbar for use in the system for composition of documents from multiple formats according to one embodiment of the subject application;

FIG. 6 is a template screenshot of the workflow toolbar in an application for use in the system for composition of documents from multiple formats according to one embodiment of the subject application;

FIG. 7 is a flowchart illustrating a method for composition of documents from multiple formats according to one embodiment of the subject application; and

FIG. 8 is a flowchart illustrating a method for composition of documents from multiple formats according to one embodiment of the subject application.

### DETAILED DESCRIPTION OF THE PREFERRED EMBODIMENT

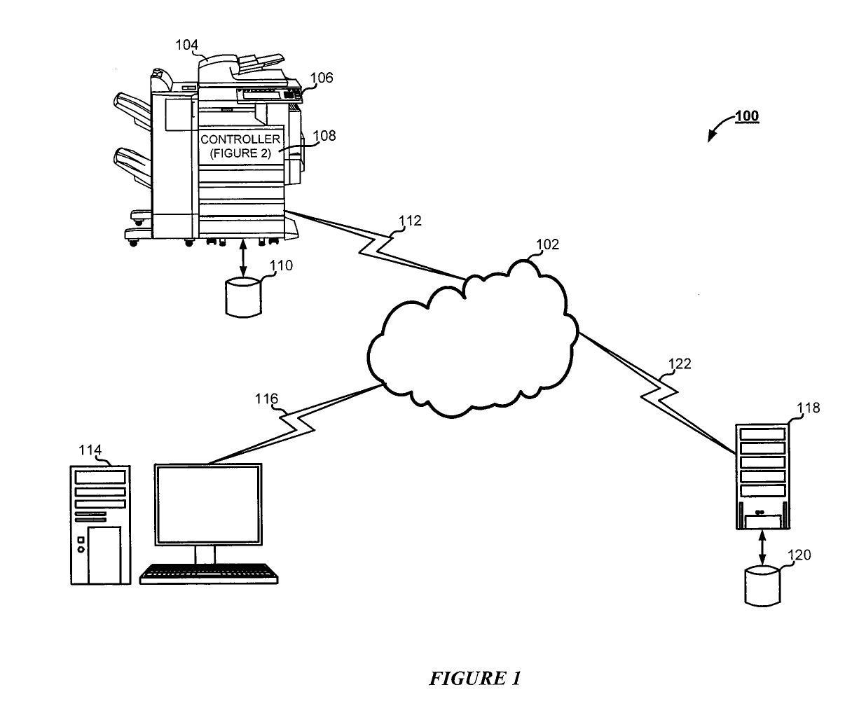

The subject application is directed to a system and method for composition of documents from multiple formats. In particular, the subject application is directed to a system and method for generating an electronic document from multiple sources. More particularly, the subject application is directed to a system and method that allows a user to compose or assemble a document from multiple files or software applications. It will become apparent to those skilled in the art that the system and method described herein are suitably adapted to a plurality of varying electronic fields requiring the compilation of multiple files from multiple software applications into an output file, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of the system 100 for composition of documents from multiple formats in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

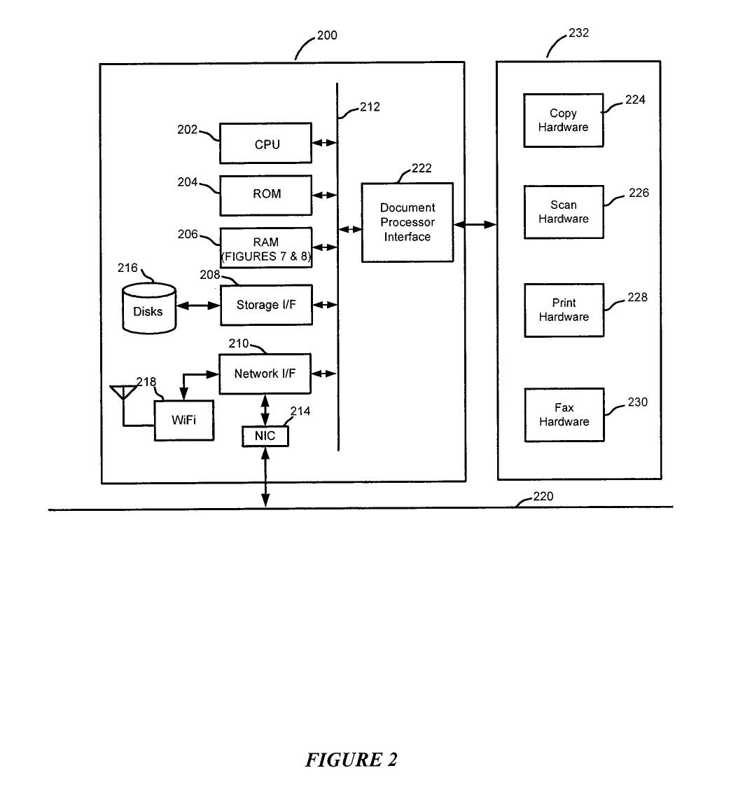

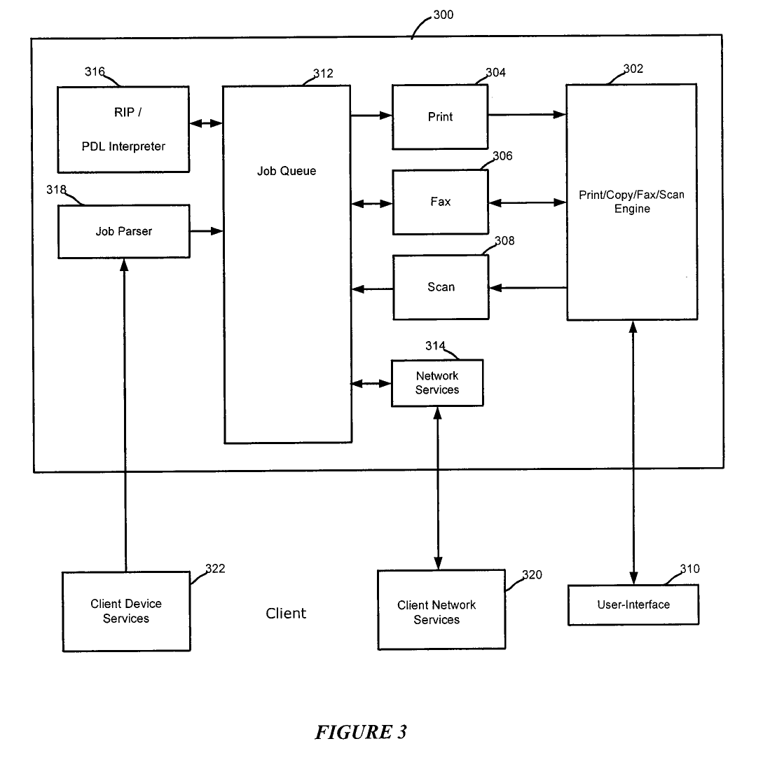

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of being employed in the system and method for composition of documents from multiple formats in accordance with one embodiment of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

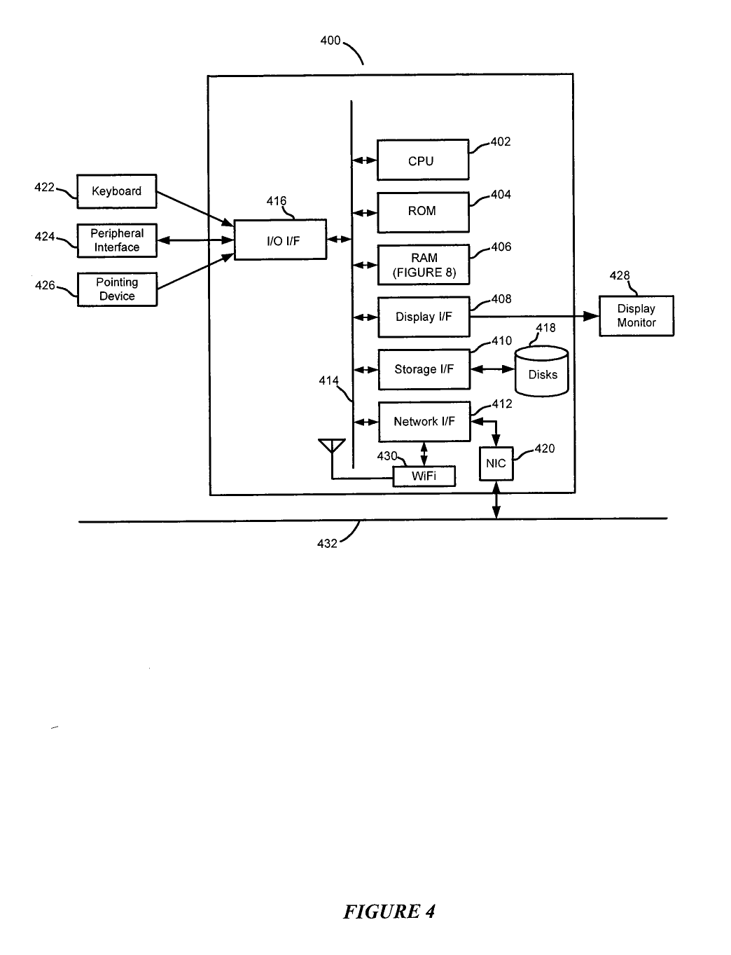

The system 100 illustrated in FIG. 1 further depicts a user device 114, in data communication with the computer network 102 via a communications link 116. It will be appreciated by those skilled in the art that the user device 114 is shown in FIG. 1 as a workstation for illustration purposes only. As will be understood by those skilled in the art, the user device 114 is representative of any computing device known in the art, including, for example and without limitation, a laptop computer, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102. In accordance with one embodiment of the subject application, the workstation 114 is suitably adapted to run a plurality of document composition applications, including, for example and without limitation, MICROSOFT WORD, CORELL WORDPERFECT, MICROSOFT EXCEL, ADOBE ACROBAT, MICROSOFT OFFICE programs, or any other suitable word processing, data manipulation, spreadsheets, imaging applications, and the like. The operation of the user device 114 will better be understood in conjunction with the block diagram illustrated in FIG. 4, explained in greater detail below.

The system 100 further illustrates a network storage server 118 coupled to a data storage device 120. Preferably, the network storage server 118 is representative of any network storage device known in the art capable of storing document data, image data, video data, sound data, multimedia data, or other suitable electronic data, as will be known in the art. In accordance with one embodiment of the subject application, the data storage device 120 includes a plurality of electronic data, including image data, document data, or the like. The network storage server 118 is communicatively coupled to the computer network 102 via a suitable communications link 122. As will be understood by those skilled in the art, the communications link 122 includes, for example and without limitation a proprietary communications network, infrared, optical, Bluetooth, WiMax, 802.11a, 802.11b, 802.11g, 802.11(x), the public switched telephone network, or any suitable wireless data transmission system, or wired communications known in the art.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by the processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with bus the 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that a controller suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with the document processing device 200. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image processor, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The Parser 318 functions to interpret a received electronic document file and relay it to the job queue 312 for handling in connection with the afore-described functionality and components.

Turning now to FIG. 4, illustrated is a hardware diagram of a suitable workstation 400 (illustrated FIG. 1 as the user device 114) for use in connection with the subject system. A suitable workstation includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

The read only memory 404 suitably includes firmware, such as static data or fixed instructions, such as BIOS, system functions, configuration data, and other routines used for operation of the workstation 400 via CPU 402.

The random access memory 406 provides a storage area for data and instructions associated with applications and data handling accomplished by the processor 402.

The display interface 408 receives data or instructions from other components on the bus 414, which data is specific to generating a display to facilitate a user interface. The display interface 408 suitably provides output to a display terminal 428, suitably a video display device such as a monitor, LCD, plasma, or any other suitable visual output device as will be appreciated by one of ordinary skill in the art.

The storage interface 410 suitably provides a mechanism for non-volatile, bulk or long term storage of data or instructions in the workstation 400. The storage interface 410 suitably uses a storage mechanism, such as storage 418, suitably comprised of a disk, tape, CD, DVD, or other relatively higher capacity addressable or serial storage medium.

The network interface 412 suitably communicates to at least one other network interface, shown as network interface 420, such as a network interface card, and wireless network interface 430, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 420 is interconnected for data interchange via a physical network 432, suitably comprised of a local area network, wide area network, or a combination thereof.

An input/output interface 416 in data communication with the bus 414 is suitably connected with an input device 422, such as a keyboard or the like. The input/output interface 416 also suitably provides data output to a peripheral interface 424, such as a USB, universal serial bus output, SCSI, Firewire (IEEE 1394) output, or any other interface as may be appropriate for a selected application. Finally, the input/output interface 416 is suitably in data communication with a pointing device interface 428 for connection with devices, such as a mouse, light pen, touch screen, or the like.

In operation, document selection data representing a selected set of a plurality of electronic documents in mutually distinct formats is first received. Document data, including link data associated with a link to each selected electronic document and metadata associated with the format of each selected electronic document are stored. Document finishing data representing at least one output form associated with an output document is then received. An output is then commenced corresponding to each of the selected set of electronic documents and corresponding document data to an associated document processing device. The associated document processing device then commences an output of an output document including each selected electronic document according to the received finishing data.

In accordance with one example embodiment of the subject application, document selection data is received from an associated user via a suitable application resident on the workstation 114. Preferably, the document selection data is representative of a selected set of a plurality of electronic documents encoded in mutually distinct formats. For example, a user via the workstation 114 selects electronic documents in a variety of formats, such as a .doc format, an .xls format, .ppt format, a .pdf format, a .gif format, a .jpg format, a .pcx format, a .tiff format, a .raw format, .png format, a .dwg format, a .dxf format, or the like. It will be appreciated by those skilled in the art that the electronic documents selected by the user are capable of being generated by the workstation, stored in memory thereon, stored in the data storage device 110, stored in the network storage server 118 and associated data storage device 120, stored on a portable storage medium, or any other suitable networked device.

The selected documents, in the form of link data associated with a link to each selected electronic document and metadata associated with the format of each selected document is then stored by the workstation 114. It will be appreciated by those skilled in the art that the instant example references the workstation 114 as performing these operations, e.g., receiving the user selection data and compiling the composite document, however the skilled artisan will understand that the controller 108 or other component of the document processing device 104, or other networked device, is equally capable of performing these operations in accordance with the subject application.

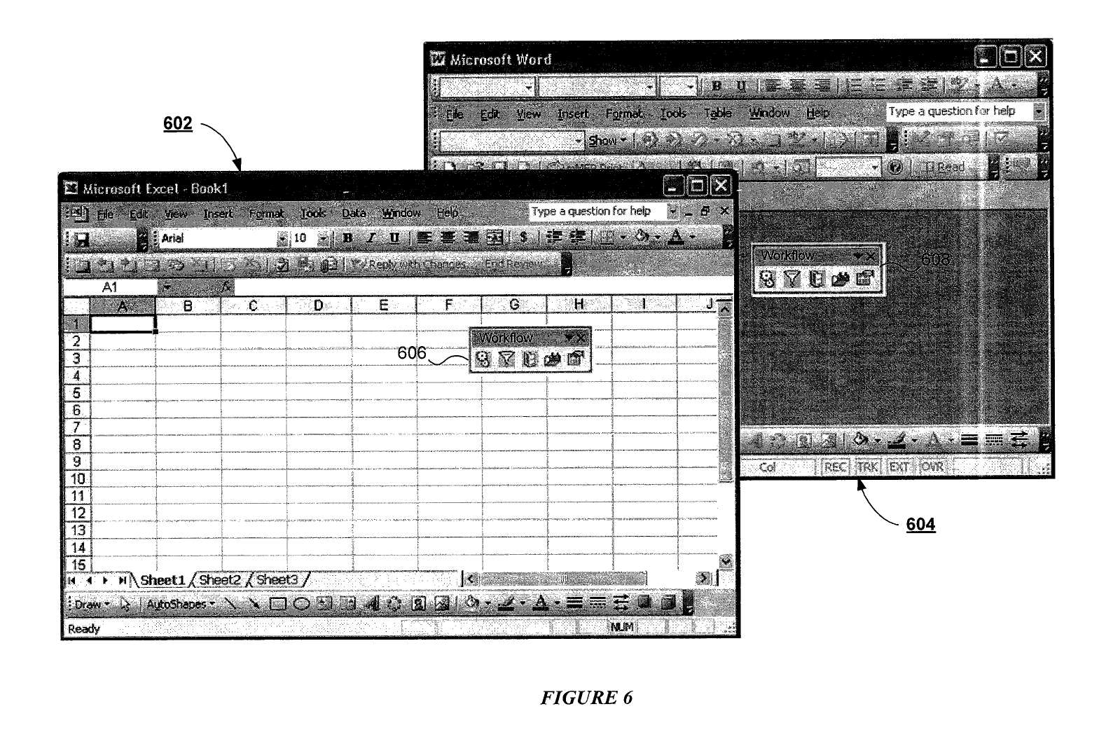

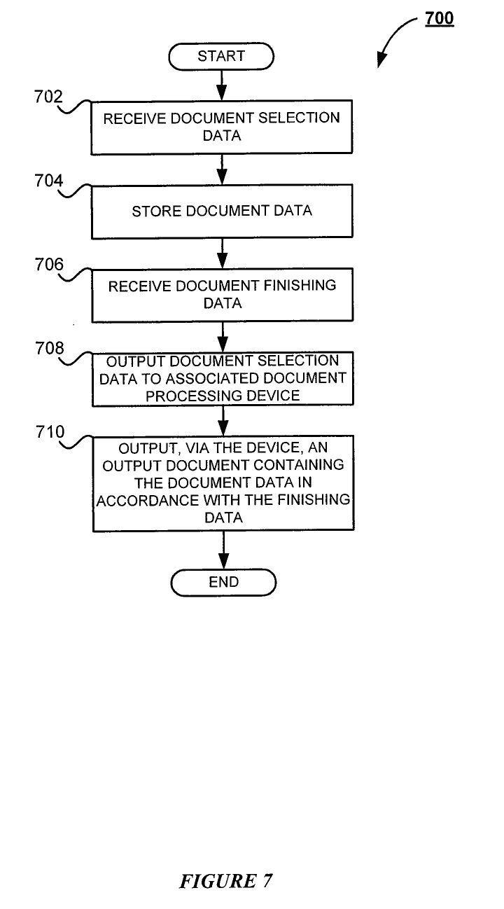

A user interface is then generated on the workstation 114 via a suitable printer driver including image data representing an output form. In accordance with one embodiment of the subject application, the user interface includes an icon corresponding to each output form. User selected finishing data is then received via the printer driver corresponding to finishing options selected by the user. Preferably, the finishing data is selected by the selection of an icon selected by the associated user. In accordance with one embodiment of the subject application, a toolbar (shown in detail in FIGS. 6 and 7) is incorporated into the application on the workstation 114, such that the toolbar icons correspond to output formats selectable by the user. As will be understood by those skilled in the art, suitable finishing options include, for example and without limitation, stapling, number of copies, collation, cover page generation, hole punch, and the like. Each selected electronic document is then retrieved by the printer driver according to the selection data. Thus, the printer driver retrieves each selected electronic document from its storage location, as determined by the link data and the metadata. For example and without limitation, the printer driver is capable of retrieving a WORD document from the data storage device 110, an EXCEL document from the network storage device 120, and a PORTABLE DOCUMENT FORMAT from the workstation 114.

Image data is then generated, via the printer driver on the workstation 114, representing the selected set of electronic documents. Ordering data is then received by the printer driver from the associated user corresponding to a selected order of each of the selected set of electronic documents. The skilled artisan will appreciate that the user is thereby able to select the order of the selected documents in the composite document being generated in accordance with one embodiment of the subject application. Once the printer driver associated with the workstation 114 has received all user selections, retrieved the selected documents, and generated the order set by the user, the driver outputs document selection data to the document processing device 104 via the computer network 102. Preferably, the output document selection data is sent in accordance with the ordering set by the associated user. The document processing device 104 then outputs an output document containing the document data in accordance with the finishing data and ordering set by the user. That is, the document processing device 104 then generates an output document representing a composite document including each of the electronic documents in varying formats, in the order selected by the user, with the finishing options. In accordance with one embodiment of the subject application, the printer driver is capable of outputting the document selection data to a viewable format file, e.g., PORTABLE DOCUMENT FORMAT file, which incorporates each selected document in accordance with the ordering set by the associated user. Thus, the skilled artisan will appreciate that such a viewable format file is then capable of being output via the document processing device 104 at a later point in time. It will further be appreciated by those skilled in the art that the user is able to make the foregoing selections via a toolbar that is displayed in each application, e.g., WORD, EXCEL, ADOBE ACROBAT, VISIO, and the like.

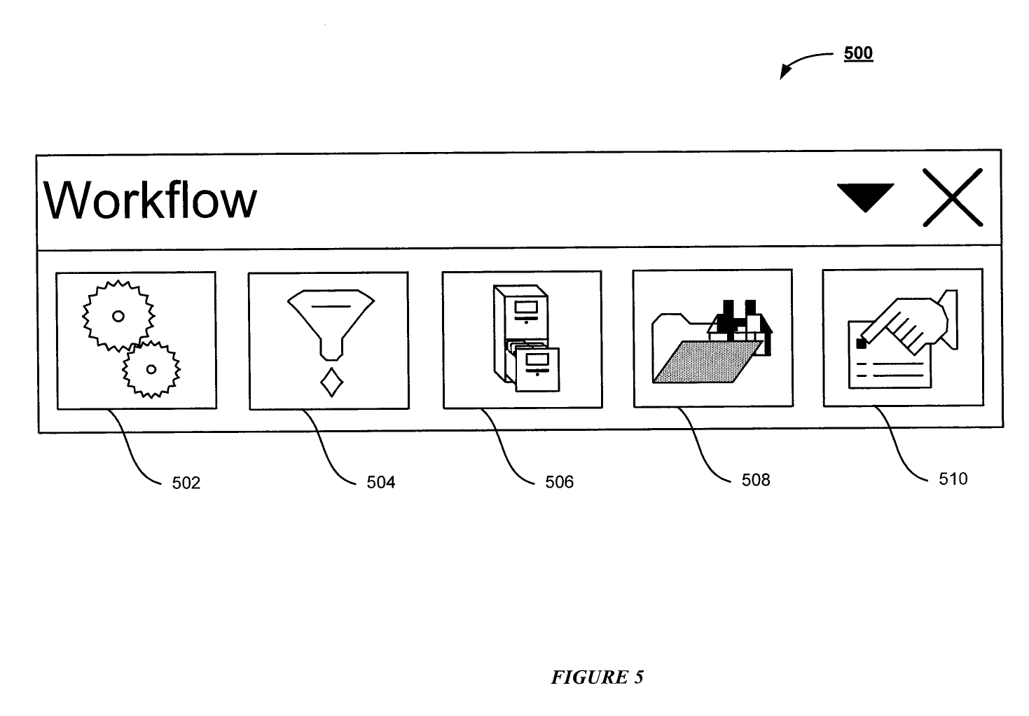

Turning now to FIG. 5, there is shown a template toolbar 500 illustrating workflow icons for use in accordance with one embodiment of the subject application. As mentioned s above, the toolbar 500 is suitably adapted to be displayed in each application on the workstation 114 capable of manipulating a supported file format. The skilled artisan will appreciate that the toolbar 500 is intended to represent one embodiment of available functionality in accordance with the subject application and not to limit the application thereto. As shown in FIG. 5, the toolbar 500 includes a graphical icon 502 representing a print directly with pre-configured settings operation, a graphical icon 504 representing a scan capture to desktop operation, a graphical icon 506 representing a send directly to document management operation, a graphical icon 508 representing a document builder from multiple applications (e.g., formats), and a graphical icon 510 representing at least one automated operation to be performed on a document and subsequently integrating the modified document into a document management system or enterprise content management system operation. The skilled artisan will appreciate that other operations are capable of inclusion into the toolbar including, for example and without limitation, an icon representing a printer driver, an icon representing finishing options, an icon representing device selection, an icon representing document location, or the like. It will be apparent to those skilled in the art that the selection, for example, of the document builder icon 508, prompts the user to select a set of electronic documents to be included into an output document representing a composite of each of the selected set of documents. Other applications will be apparent to those skilled in the art in accordance with the subject application.

Referring now to FIG. 6, there is shown an example implementation of the toolbar 500 in screenshots 602 and 604, illustrating the use of the toolbar 500 in multiple applications. As shown in FIG. 6, the screenshot 602 is an example spreadsheet in a MICROSOFT EXCEL application, whereas the screenshot 604 is an example of a word processing document in a MICROSOFT WORD application. Each application includes a corresponding toolbar, 606 and 608, respectively, representing an implementation of the toolbar 500 in each application. The skilled artisan will appreciate that such an embodiment, as illustrated in FIG. 6, enables the user to select documents for generation of a composite document from any supporting application.

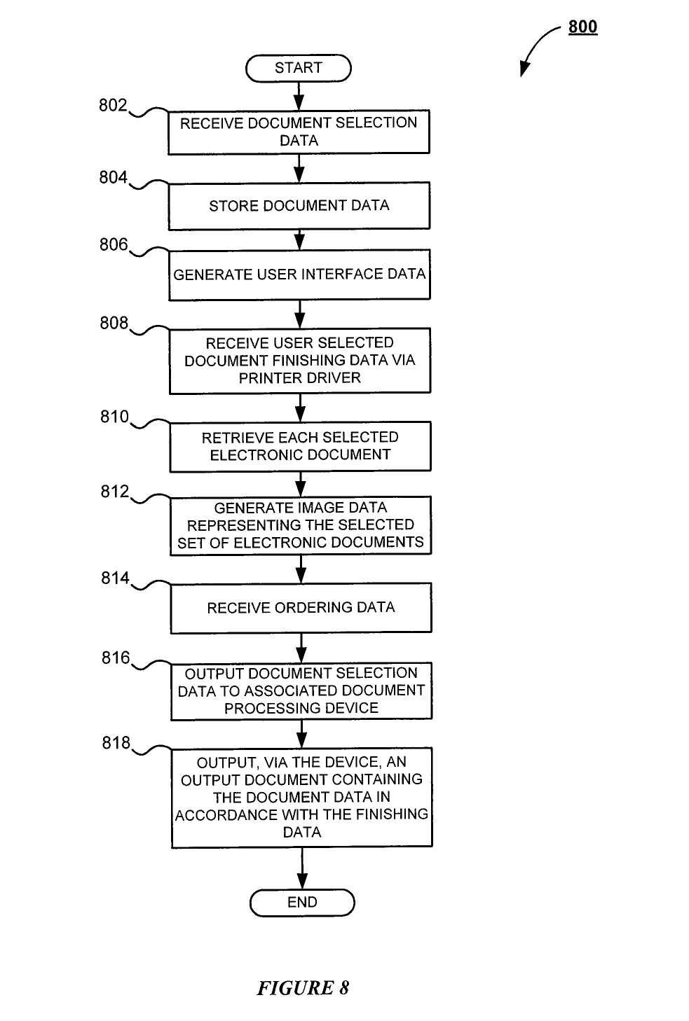

The skilled artisan will appreciate that the subject system 100 and components described above with respect to FIG. 1, FIG. 2, FIG. 3, FIG. 4, FIG. 5, and FIG. 6 will be better understood in conjunction with the methodologies described hereinafter with respect to FIG. 7 and FIG. 8. Turning now to FIG. 7, there is shown a flowchart 700 illustrating a method for composition of documents from multiple formats in accordance with one embodiment of the subject application. Beginning at step 702, document selection data representing a selected set of a plurality of electronic documents encoded in mutually distinct formats is first received. At step 704, document data, including link data associated with a link to each selected electronic document and metadata associated with the format of each selected electronic document are stored. Finishing data is then received at step 706 representing at least one output form associated with an output document. At step 708, an output is then commenced to an associated document processing device corresponding to each of the selected set of electronic documents and corresponding document data. The associated document processing device then commences, at step 710, an output of an output document including each selected electronic document according to the received finishing data.

Referring now to FIG. 8, there is shown a flowchart 800 illustrating a method for composition of documents from multiple formats in accordance with one embodiment of the subject application. The method depicted in the flowchart 800 of FIG. 8 begins at step 802, wherein document selection data representing a selected set of a plurality of electronic documents encoded in mutually distinct formats is received. Preferably, the selection data is received by a printer driver resident on the workstation 114 and corresponds to a user selection of a plurality of electronic documents to be composited into an output document. Document data, including link data associated with a link to each selected document, i.e., a filename/path, hyperlink, or the like, and metadata associated with a format of each selected electronic document, i.e., .doc, .xls, .pdf, .ppt, .jpeg, .gif, .png, .wpd, or the like, is stored by the printer driver at step 804. It will be appreciated by those skilled in the art that the printer driver is capable of residing on any of a myriad of network devices, thereby enabling a user to initiate the subject application from any such device. For example, the user is capable of initiating the subject application directly via the document processing device 104, using the associated user interface 106. In accordance with a further example, a personal data assistant or laptop computer in data communication with the computer network 102 is capable of implementing the printer driver, whereby the printer driver resident on the personal data assistant or laptop computer facilitates the selection and composition of the composite document, as set forth above with respect to the workstation 114.

At step 806, user interface data is generated by the printer driver corresponding to at least one output form on the workstation 114. It will be appreciated by those skilled in the art that the user interface is capable of comprising a toolbar, such as the toolbar 500 of FIG. 5, incorporating an icon associated with each output form. Flow then proceeds to step 808, whereupon user selected document finishing data is received by the printer driver from the associated user. In accordance with one embodiment of the subject application, the selection of finishing data corresponds to a user selection of an icon in the toolbar 500. It will be understood by those skilled in the art that suitable finishing options include, for example and without limitation, stapling, hole-punching, number of copies, collation, cover page, or the like. In accordance with the document selection data, the printer driver retrieves each selected document at step 810. It will be appreciated by those skilled in the art that such retrieval is capable of including, for example and without limitation, using the link data to retrieve a document from the network storage device 120, the data storage device 110, local storage on the workstation 114, a portable medium, or the like.

Image data is then generated at step 812 representing the selected set of electronic documents. Preferably, this image data is displayed to the user on the workstation 114, or alternatively, on the user interface 106 of the document processing device 104. At step 814, ordering data representing the order in which the selected set of electronic documents are to be arranged in the output composite document, is received from the associated user. In accordance with one embodiment of the subject application, the user is able to manipulate the image data so as to arrange the selected documents in the desired order. At step 816, the document selection data is output by the printer driver to the associated document processing device 104 in accordance with the ordering data and selected finishing data. The document processing device 104 then outputs the composite output document based on the ordering data and the finishing data at step 818.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for composition of documents from multiple formats comprising:
means adapted for receiving document selection data representative of a selected set of a plurality of electronic documents encoded in mutually distinct formats;
data storage adapted for storing document data, including link data associated with a link to each selected electronic document and metadata associated with a format of each selected electronic document;
means adapted for receiving document finishing data representative of at least one output form associated with an output document;
means adapted for commencing an output corresponding to each of the selected set of electronic documents and corresponding document data to an associated document processing device; and
output means adapted for commencing an output, via the associated document processing device, of an output document inclusive of each selected electronic document in accordance with received finishing data.

2. The system for composition of documents from multiple formats of claim 1 wherein the finishing data includes data representative of at least one output form chosen from the set comprising stapling, number of copies, collation and cover page generation.

3. The system for composition of documents from multiple formats comprising of claim 2 further comprising a printer driver resident on a workstation, the printer driver including:
means adapted for generating a user interface inclusive of image data representative of the at least one output form;
means adapted for retrieving each selected electronic document in accordance with document selection data; and
wherein the means adapted for receiving the document finishing data is disposed within the printer driver.

4. The system for composition of documents from multiple formats of claim 3 wherein the user interface includes an icon corresponding to each output form, and further comprising means adapted for receiving the document finishing data in accordance with a user selection of an icon on the user interface.

5. The system for composition of documents from multiple formats of claim 2 further comprising:
means adapted for generating image data representative of the selected set of electronic documents;
means adapted for receiving ordering data representative of a selected ordering of each of the selected set of electronic documents; and
wherein the output means includes means adapted for commencing an output of the output document in accordance with received ordering data.

6. A method for composition of documents from multiple formats comprising the steps of:
receiving document selection data representative of a selected set of a plurality of electronic documents encoded in mutually distinct formats;
storing document data, including link data associated with a link to each selected electronic document and metadata associated with a format of each selected electronic document;
receiving document finishing data representative of at least one output form associated with an output document;
commencing an output corresponding to each of the selected set of electronic documents and corresponding document data to an associated document processing device; and
commencing an output, via the associated document processing device, of an output document inclusive of each selected electronic document in accordance with received finishing data.

7. The method for composition of documents from multiple formats of claim 6 wherein the finishing data includes data representative of at least one output form chosen from the set comprising stapling, number of copies, collation and cover page generation.

8. The method for composition of documents from multiple formats comprising of claim 7 further comprising the steps of:
generating a user interface inclusive of image data representative of the at least one output form via a printer driver resident on a workstation;
retrieving each selected electronic document in accordance with document selection data via the printer driver; and
wherein the step of receiving the document finishing data is received via the printer driver.

9. The method for composition of documents from multiple formats of claim 8 wherein the user interface includes an icon corresponding to each output form, and further comprising the step of receiving the document finishing data in accordance with a user selection of an icon on the user interface.

10. The method for composition of documents from multiple formats of claim 7 further comprising the steps of:
generating image data representative of the selected set of electronic documents;
receiving ordering data representative of a selected ordering of each of the selected set of electronic documents; and
wherein the step of commencing an output includes commencing an output of the output document in accordance with received ordering data.

11. A computer-implemented method for composition of documents from multiple formats comprising the steps of:
receiving document selection data representative of a selected set of a plurality of electronic documents encoded in mutually distinct formats;
storing document data, including link data associated with a link to each selected electronic document and metadata associated with a format of each selected electronic document;
receiving document finishing data representative of at least one output form associated with an output document;
commencing an output corresponding to each of the selected set of electronic documents and corresponding document data to an associated document processing device; and
commencing an output, via the associated document processing device, of an output document inclusive of each selected electronic document in accordance with received finishing data.

12. The computer-implemented method for composition of documents from multiple formats of claim 11 wherein the finishing data includes data representative of at least one output form chosen from the set comprising stapling, number of copies, collation and cover page generation.

13. The computer-implemented method for composition of documents from multiple formats comprising of claim 12 further comprising the steps of:
generating a user interface inclusive of image data representative of the at least one output form via a printer driver resident on a workstation;
retrieving each selected electronic document in accordance with document selection data via the printer driver; and
wherein the step of receiving the document finishing data is received via the printer driver.

14. The computer-implemented method for composition of documents from multiple formats of claim 13 wherein the user interface includes an icon corresponding to each output form, and further comprising the step of receiving the document finishing data in accordance with a user selection of an icon on the user interface.

15. The computer-implemented method for composition of documents from multiple formats of claim 12 further comprising the steps of:
generating image data representative of the selected set of electronic documents;
receiving ordering data representative of a selected ordering of each of the selected set of electronic documents; and
wherein the step of commencing an output includes commencing an output of the output document in accordance with received ordering data.
